(19) United States
(12) Patent Application Publication
(10) Pub. No.: US 2026/0321815 A1
(43) Pub. Date: Oct. 15, 2026

(54) COMPOSITE BATTERY CELL ENCLOSURE

(71) Applicant: GM Global Technology Operations LLC, Detroit, MI (US)

(72) Inventors: Seung-Woo Chu, Sterling Heights, MI (US); Sriniket Achar, Sterling Heights, MI (US)

(73) Assignee: GM Global Technology Operations LLC, Detroit, MI (US)

(21) Appl. No.: 19/176,509

(22) Filed: Apr. 11, 2025

(51) Int. Cl. H01M 50/126; H01M 10/653; H01M 50/105; H01M 50/119; H01M 50/121; H01M 50/124; H01M 50/178; H01M 50/211; H01M 50/249

(52) U.S. Cl. CPC H01M 50/126; H01M 10/653; H01M 50/105; H01M 50/119; H01M 50/121; H01M 50/1243; H01M 50/1245; H01M 50/178; H01M 50/211; H01M 50/249; H01M 2220/20

(57) ABSTRACT

A battery cell including an electrode that has a cathode, an anode, and a separator. The battery cell includes an inner enclosure at least partially surrounding the electrode assembly. The inner enclosure includes a shallow-drawn metallic housing having an inner surface that is at least partially coated with a first polypropylene (PP) layer, a closure member including a second PP layer that is sealed to the first PP layer of the shallow-drawn metallic housing, and at least one lead tab electrically connected to the electrode assembly and extending outwardly from the inner enclosure. The battery cell includes an outer enclosure surrounding at least a portion of the inner enclosure. The outer enclosure has a coating layer that includes aluminum tri-hydrate (ATH). The outer enclosure has a first region with a first thickness and a second region with a second thickness greater than the first thickness.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to battery systems and, more particularly, to a battery cell enclosure for battery cells and battery packs.

Lithium-ion batteries are prevalent in portable electronics, electric vehicles, and grid-scale energy storage, offering high energy density and rechargeability. Battery systems often combine multiple cells, such as cylindrical, prismatic, or pouch-type, to meet specific voltage and capacity needs. These cells utilize electrochemical reactions between a cathode, an anode, and an electrolyte, separated by a physical barrier. Material selection for these components dictates cell performance. Enclosure design and assembly are important to overall battery function. Battery packs integrate individual cells, providing electrical connections and mechanical support.

### SUMMARY

One aspect of the disclosure provides a battery cell that has an electrode assembly including a cathode, an anode, and a separator. The battery cell includes an inner enclosure at least partially surrounding the electrode assembly. The inner enclosure includes a shallow-drawn metallic housing having an inner surface that is at least partially coated with a first polypropylene (PP) layer, a closure member including a second PP layer, and at least one lead tab electrically connected to the electrode assembly and extending outwardly from the inner enclosure. The second PP layer of the closure member is sealed to the first PP layer of the shallow-drawn metallic housing. The battery cell includes an outer enclosure surrounding at least a portion of the inner enclosure. The outer enclosure has a coating layer that includes aluminum tri-hydrate (ATH). The outer enclosure has a first region with a first thickness and a second region with a second thickness greater than the first thickness.

Implementations of the disclosure may include one or more of the following optional features. In some implementations, a portion of the coating layer includes an outer sub-layer that has a blend of ATH powder and glass bubbles. Here, the portion of the coating layer may interface with another battery cell. In these implementations, the glass bubbles may include soda-lime borosilicate glass. The glass bubbles may have a diameter between 15 μm and 70 μm. The glass bubbles may have a density between 0.1 g/cc and 0.5 g/cc. In some examples, the first region interfaces a thermal interface material. The second region may interface another battery cell. In some implementations, the closure member includes a multi-layer laminated aluminum pouch.

Another aspect of the disclosure provides a battery pack including a first battery cell and a second battery cell. Each respective battery cell includes an electrode assembly that has a cathode, an anode, and a separator, and an inner enclosure at least partially surrounding the electrode assembly. The inner enclosure includes a shallow-drawn metallic housing having an inner surface that is at least partially coated with a first polypropylene (PP) layer, a closure member that has a second PP layer, and at least one lead tab electrically connected to the electrode assembly and extending outwardly from the inner enclosure. The second PP layer of the closure member is sealed to the first PP layer of the shallow-drawn metallic housing. The battery pack includes an outer enclosure surrounding at least a portion of the inner enclosure of the first battery cell and the second battery cell. The outer enclosure has a coating layer that includes aluminum tri-hydrate (ATH). The outer enclosure has a first region with a first thickness and a second region with a second thickness greater than the first thickness.

Implementations of the disclosure may include one or more of the following optional features. In some implementations, the closure member of the first battery cell interfaces with the closure member of the second battery cell. In some examples, a portion of the coating layer that has an outer sub-layer that has a blend of ATH powder and glass bubbles. Here, the portion of the coating layer may interface with another battery cell. In these examples, the glass bubbles may include soda-lime borosilicate glass. The first region may interface with a thermal interface material. In some implementations, the second region of the first battery cell interfaces the second region of the second battery cell.

Another aspect of the disclosure provides a battery pack including a first battery cell and a second battery cell. Each respective battery cell includes an electrode assembly that has a cathode, an anode, and a separator, and an inner enclosure at least partially surrounding the electrode assembly. The inner enclosure includes a shallow-drawn metallic housing, a flange attached to the shallow-drawn metallic housing, and at least one lead tab electrically connected to the electrode assembly and extending outwardly from the inner enclosure. The battery pack includes an outer enclosure surrounding at least a portion of the inner enclosure of the first battery cell and the second battery cell. The outer enclosure has a coating layer that includes aluminum tri-hydrate (ATH).

Implementations of the disclosure may include one or more of the following optional features. In some implementations, the flange of the first battery cell interfaces with the flange of the second battery cell. In some examples, a portion of the coating layer includes an outer sub-layer that has a blend of ATH powder and glass bubbles. In these examples, the glass bubbles may include soda-lime borosilicate glass.

The details of one or more implementations of the disclosure are set forth in the accompanying drawings and the description below. Other aspects, features, and advantages will be apparent from the description and drawings, and from the claims.

### BRIEF DESCRIPTION OF THE DRAWINGS

The drawings described herein are for illustrative purposes only of selected configurations and are not intended to limit the scope of the present disclosure.

FIG. 1 is a front perspective view of a vehicle according to principles of the present disclosure.

FIG. 2 is a front perspective view of an inner enclosure of a battery cell.

FIG. 3 is an exploded view of the inner enclosure of the battery cell of FIG. 2.

FIG. 4A is a cross-sectional side view of a single battery cell with an inner enclosure and an outer enclosure.

FIGS. 4B and 4C are cross-sectional side views of a two battery cells with inner enclosures and a single outer enclosure.

FIG. 5A is a cross-sectional side view of an outer enclosure of the battery cell.

FIGS. 5B and 5C are detailed views of a coating layer of the outer enclosure of FIG. 5A.

FIG. 5D is a detailed view of a coating layer with an outer sub-layer of FIG. 5A.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Electric vehicles can be equipped with a battery pack that includes one or more battery cells. Lithium-ion batteries are typically used in vehicles due to their high energy and power densities. Sometimes, however, a chain of uncontrolled exothermic reactions can occur within the lithium-ion batteries (i.e., thermal runaway). These reactions can result in a rise in internal temperature of the battery that causes inner structures of the battery to destabilize and degrade and eventually lead to failure of the battery and/or damage to the vehicle.

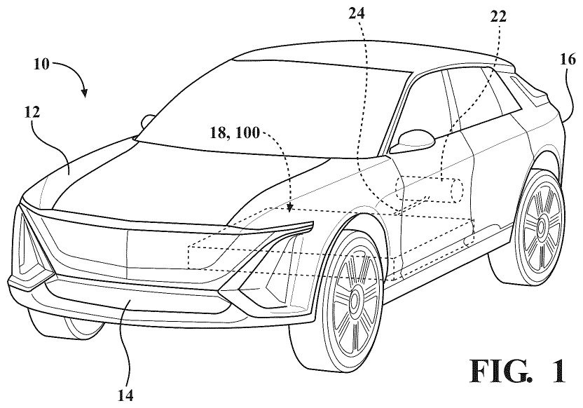

FIG. 1 illustrates an example vehicle 10 that has a vehicle body 12 extending from a first end 14 to a second end 16. The vehicle 10 includes a battery pack 18 coupled to the vehicle body 12. The battery pack 18 includes one or more battery cells 100 communicatively coupled to one another. The battery cells 100 may include cylindrical battery cells, prismatic battery cells, or another cell design used in the automotive industry. The battery pack 18 is communicatively coupled to an electric motor 22 that is coupled to the vehicle body 12 via a cable 24. This electrical coupling allows the battery pack 18 to supply electrical power to the electric motor 22, thereby driving the vehicle 10. The cable 24 facilitates the transmission of electrical power between the battery pack 18 and the electric motor 22, enabling the electric motor 22 to convert electrical energy into mechanical energy for vehicle propulsion.

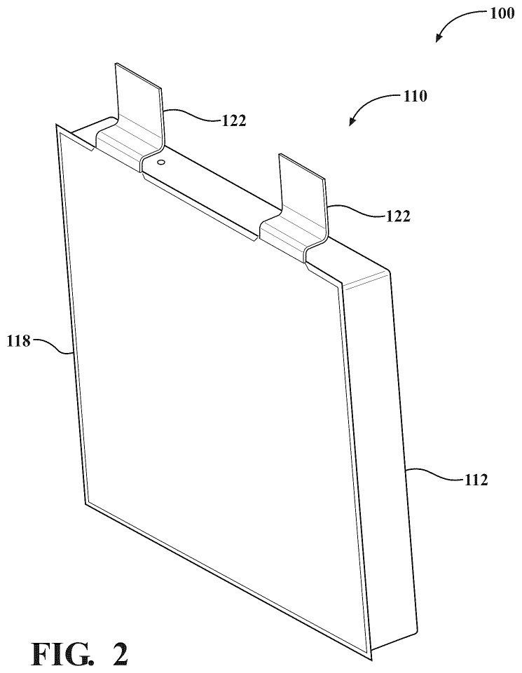

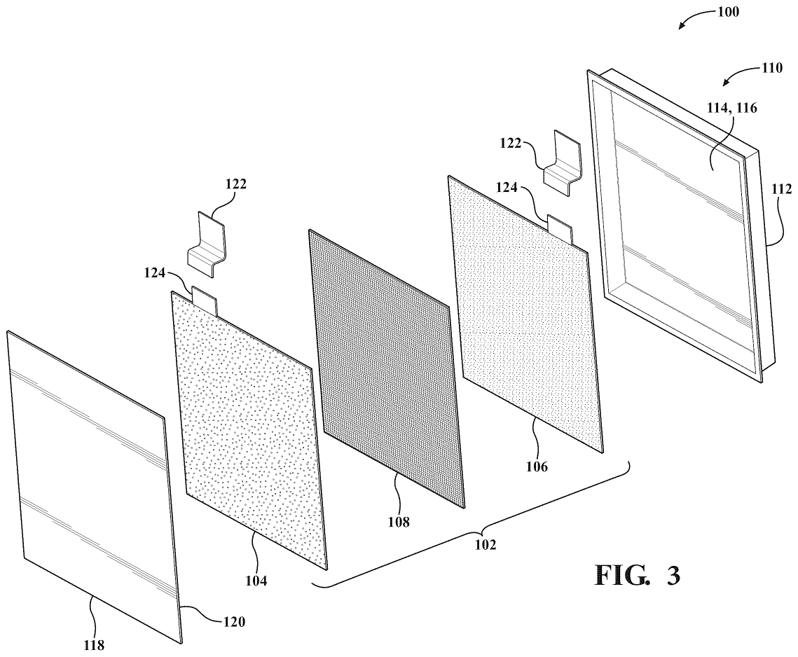

With reference to FIGS. 2 and 3, the battery cell 100 is configured for use in applications requiring high energy density and efficient packaging, such as electric vehicles and rechargeable energy storage systems. In the present example, the battery cell 100 is a prismatic battery cell characterized by a substantially rectangular, box-like geometry, which optimizes volumetric efficiency. The battery cell 100 includes an electrode assembly 102 that has a cathode 104, an anode 106, and a separator 108. The cathode 104 and the anode 106 are electrodes with opposite polarities. The cathode 104 is a positive electrode and the anode 106 is a negative electrode.

During operation, specifically during discharge of the battery cell 100, lithium ions flow from the anode 106 to the cathode 104 through an electrolyte, and electrons flow through an external circuit, thereby generating an electrical current. This flow of ions and electrons provides the electrical energy output of the battery cell 100. During charging, this process is reversed, and electrons flow in the opposite direction through the external circuit, storing energy within the battery cell 100. The separator 108 is positioned between the cathode 104 and the anode 106 to prevent electrical shorting. The separator 108 is a porous, electrically insulating material that allows ion transport but prevents direct physical contact between the cathode 104 and the anode 106.

The battery cell 100 further includes an inner enclosure 110 that at least partially surrounds the electrode assembly 102. As such, the inner enclosure 110 provides a sealed environment for the electrode assembly 102. More specifically, the inner enclosure 110 includes a shallow-drawn metallic housing 112. The shallow-drawn metallic housing 112 may be shaped as a five-sided, open-topped, prismatic container, characterized by a base and four upstanding sidewalls that define a rectangular cavity. Each sidewall extends perpendicularly from the base, and all sidewalls are of a uniform height, creating a consistent depth for the cavity. The base and sidewalls collectively form a box-like structure with a single open face, allowing for insertion and subsequent sealing of the electrode assembly 102. The shallow-drawn process involves forming a sheet of metal into a desired shape by pressing it into a die in one or more draw steps. Notably, the shallow-drawn process is less complex and less costly than the deep-drawing process used in traditional prismatic battery cells. The shallow-drawn metallic housing 112 also offers advantages in terms of weight reduction compared to deep-drawn housings, which can be crucial for improving the overall energy density of the battery pack 18. The shallow-drawn metallic housing 112 may have a thermal conductivity of over 230 watts per meter-Kelvin (W/mK).

The shallow-drawn metallic housing 112 has an inner surface 114 that is at least partially coated with a first polypropylene (PP) layer 116. The inner enclosure 110 may also include a closure member 118 that has a second PP layer 120. The closure member 118 may be sealed to the open face of the shallow-drawn metallic housing 112, thereby enclosing the electrode assembly 102. In particular, the first PP layer 116 provides a thermoplastic surface that, when heated, effectively bonds with the second PP layer 120 of the closure member 118. Specifically, the PP material, when heated to its melting point and then cooled under pressure, allows for a strong, cohesive bond between the first PP layer 116 of the shallow-drawn metallic housing 112 and the second PP layer 120 of the closure member 118. This is advantageous because PP is a non-conductive polymer, preventing short circuits, and its low melting point allows for efficient, low-energy heat sealing. The first PP layer 116 may cover the entirety of the inner surface 114. Alternatively, the first PP layer 116 may partially cover the inner surface 114. Partial coverage may be implemented, for example, in regions where bonding with the closure member 118 is not required. In some configurations, the first PP layer may have a maximum thickness of 100 μm.

The closure member (i.e., pouch material) 118 may include a multi-layer laminated aluminum pouch. Advantageously, the closure member 118 provides flexibility to more easily install the electrode assembly 102 compared to traditional prismatic battery cells, simplifying the assembly process. The multi-layer laminated aluminum pouch may include multiple layers, including an aluminum layer, a polypropylene layer, and a nylon layer. The aluminum layer provides a barrier against moisture and oxygen, the nylon layer adds mechanical strength and puncture resistance, and the polypropylene layer enables heat sealing. As such, the closure member functions as a flexible pouch material. The second PP layer 120 of the closure member 118 is sealed to the first PP layer 116 of the shallow-drawn metallic housing 112, for example, by heat sealing. Formation of the inner enclosure 110 occurs through this heat-sealing process, which is advantageous compared to laser welding of metals, as heat sealing does not produce metallic fumes or contaminants that may compromise product quality. Alternatively, the closure member 118 may be another PP layer that has a metal part (partial or whole coverage) or a pure metal part.

The inner enclosure 110 includes at least one lead tab 122 electrically connected to the electrode assembly 102 whereby the at least one lead tab 122 extends outwardly from the inner enclosure 110. These lead tabs 122 serve as the electrical terminals of the battery cell 100, allowing for electrical connection to external circuits or other battery cells 100 in the battery pack 18. As such, the lead tabs 122 provide the conductive pathway for current to flow into and out of the battery cell 100, enabling charging and discharging. The lead tabs 122 may be made of a highly conductive metal, such as aluminum or copper, to minimize resistance and ensure efficient current flow. For example, the cathode 104 may include a foil portion 124 that forms, or is electrically connected to, one lead tab 122, and the anode 106 may have a foil portion 124 that forms, or is electrically connected, to another lead tab 122. In some examples, the cathode 104 and the anode 106 are coated onto thin metal foil portions 124 (e.g., aluminum for the cathode 104 and copper for the anode 106) that extend to form the lead tabs 122, or separate tab materials are connected to the foil portions 124. The lead tabs 122 may be sealed to the inner enclosure 110 using a lead tab sealant that prevents electrolyte leakage and ensures electrical isolation between the lead tab 122 and the inner enclosure 110. In some examples, the sealant material is chemically resistant to the electrolyte to maintain its sealing properties over the operating temperature range and lifespan of the battery cell 100. The lead tab 122 of the cathode 104 may have a resistance value between 10 and 10,000 ohms.

The battery cell 100 includes an outer enclosure 126 surrounding at least a portion of the inner enclosure 110. The outer enclosure 126 may be partially attached to the inner enclosure 110. The attachment mechanism may utilize adhesive, glue, double-sided tape, or other suitable joining methods. The outer enclosure provides additional protection, including thermal management and mechanical support. The outer enclosure 126 has a thermal conductivity of less than 40 W/mK. The outer enclosure 126 has a coating layer 128 that includes aluminum tri-hydrate (ATH), a flame retardant and thermal management material. Upon exposure to high temperatures, such as those encountered during a thermal runaway event, ATH undergoes an endothermic decomposition, releasing water vapor and absorbing heat. Notably, the dual functionality of electrical insulation and thermal runaway protection provided by the outer enclosure 126 is particularly advantageous. In some configurations, the coating layer 128 includes a maximum of 10% polymeric binder.

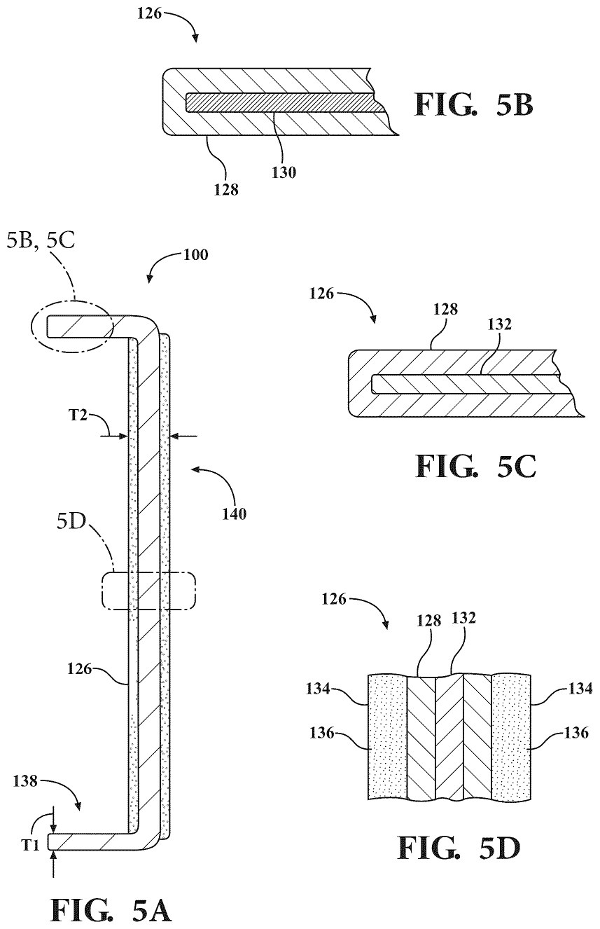

As shown in FIGS. 5A-5D, in some examples, the coating layer 128 includes an outer sub-layer 134 composed of a blend of ATH powder and glass bubbles 136. The glass bubbles 136 enhance the thermal insulation properties of the outer enclosure 126. The glass bubbles 136, which may be made of soda-lime borosilicate glass, enhance the thermal insulation properties of the outer enclosure 126. In some configurations, the glass bubbles 136 are hollow spheres that provide an insulating air gap to facilitate a reduction in heat transfer. The air gap acts as a barrier to heat flow, further improving the thermal management capabilities of the outer enclosure 126. These glass bubbles 136 may have a diameter between 15 μm and 70 μm. Moreover, the glass bubbles 136 may have a density between 0.1 grams per cubic centimeter (g/cc) and 0.5 g/cc.

As shown in FIG. 5A, in some implementations, the coating layer 128 of the outer enclosure 126 has a first thickness T1 in a first region 138 and a second thickness T2 in a second region 140 where the first thickness T1 is less than the second thickness T2. The first region 138 may interface with a thermal interface material. In some examples, the thermal interface material is a thermally conductive layer that provides heat transfer between two surfaces, such as the battery cell 100 and a cooling plate. The thermal interface material may be, for example, a thermally conductive polymer, a phase-change material, or a thermal grease, configured to minimize thermal resistance between the battery cell 100 and the cooling plate. The cooling plate may be part of a larger thermal management system, which may include liquid cooling channels or fins, to dissipate heat generated by the battery cell 100 during operation.

The second region 140 may interface with another battery cell 100. The greater second thickness T2 in the second region 140 provides increased thermal insulation between adjacent battery cells 100, minimizing the risk of thermal runaway propagating from one battery cell 100 to another. Increased insulation helps to contain a thermal event within a single battery cell 100 and prevent cascading failures throughout the battery pack 18. The difference in thicknesses between the first thickness T1 and the second thickness T2 may be tailored based on the specific thermal requirements and safety standards of the battery pack 18 application. For example, the second thickness T2 may be two to five times greater than the first thickness T1, or even more, depending on factors like cell chemistry, energy density, and the desired level of thermal isolation.

The location of the first region 138, with the first thickness T1, corresponds to the location of the cooling plate in the battery pack 18, which may vary depending on the configuration of the battery pack 18. For example, in a battery pack 18 with bottom cooling, the first region 138 would be located on the bottom surface of the outer enclosure 126, directly facing the cooling plate. Conversely, in a side-cooled configuration, the first region 138 would be located on one or more side surfaces of the outer enclosure 126. In this arrangement, the cooling plate would be positioned adjacent to the side(s) of the battery cell 100 whereby the first region 138 on the corresponding side of the outer enclosure 126 provides the primary pathway for heat transfer. Similarly, the location of the second region 140, with the second thickness T2, corresponds to the location of adjacent battery cells 100.

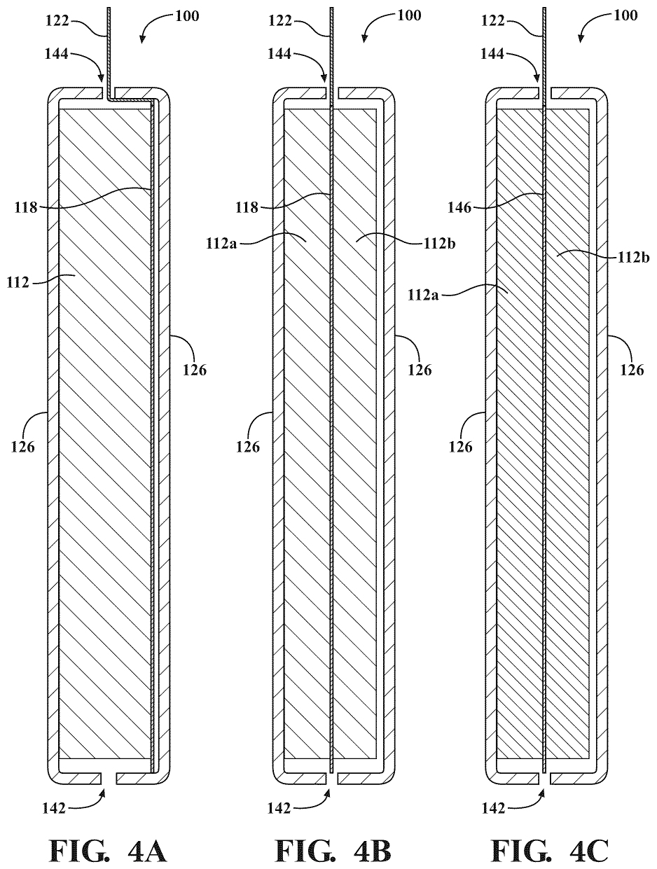

With reference to FIG. 4A, in some implementations, the outer enclosure 126 surrounds a single inner enclosure 110. That is, the outer enclosure 126 at least partially surrounds the shallow-drawn metallic housing 112, the closure member 118, and the at least one lead tab 122. In this example, the outer enclosure 126 entirely surrounds the sides of the inner enclosure 110 and partially surrounds the top and bottom sides of the inner enclosure 110. More specifically, the outer enclosure 126 includes a first opening 142 is located at the bottom side of the inner enclosure 110 and a second opening 144 is located at the top side of the inner enclosure 110 opposite the bottom side. The first opening 142 may provide a vent for interfacing with the thermal interface material. The at least one lead tab 122 passes through and extends from the second opening 144.

FIG. 4B illustrates a two-cell configuration within a single outer enclosure 126. In this example, the outer enclosure 126 surrounds a first shallow-drawn metallic housing 112a and a second shallow-drawn metallic housing 112b. The first shallow-drawn metallic housing 112a and the second shallow-drawn metallic housing 112b may be arranged such that the closure member 118 of each shallow-drawn metallic housing 112a, 112b is in contact with one another. This arrangement creates a compact, paired-cell module. The two inner enclosures 110, each containing an electrode assembly 102, are joined back-to-back, with their respective closure members 118 forming a shared internal wall. This configuration is advantageous because it doubles the energy storage capacity within a single outer enclosure 126, compared to a single-cell configuration. Here, a first shallow-drawn metallic housing 112a and a second shallow-drawn metallic housing 112b may be enclosed by the outer enclosure 126. For instance, the closure member 118 of each shallow-drawn metallic housing 112a, 112b may be in contact with one another.

More specifically, the outer enclosure 126 includes the first opening 142 that is located at the bottom side of the inner enclosure 110 and the second opening 144 that is located at the top side of the inner enclosure 110 opposite the bottom side. The first opening 142 may provide a vent for interfacing with the thermal interface material. The at least one lead tab 122 from each of the two inner enclosures 110 passes through and extends from the second opening 144. The lead tabs 122 may be connected in series or parallel, depending on the desired voltage and current characteristics of the battery pack 18. For a series connection, the positive lead tab 122 of one battery cell 100 is connected to the negative lead tab 122 of the adjacent battery cell 100. For a parallel connection, positive lead tabs 122 are connected together, and negative lead tabs 122 are connected together. The combined lead tabs 122 then exit the outer enclosure 126 through the second opening 144, providing the external electrical connection points for the two-cell module.

FIG. 4C illustrates another implementation whereby the outer enclosure 126 surrounds two inner enclosures 110. Here, a first shallow-drawn metallic housing 112a and a second shallow-drawn metallic housing 112b may be enclosed by the outer enclosure 126. In this configuration, similar to FIG. 4B, two battery cells 100, each with a shallow-drawn metallic housing 112a, 112b, are enclosed within the outer enclosure 126. This doubles the energy storage capacity within the single outer enclosure 126, as compared to a single cell configuration. However, in contrast to the configuration shown in FIG. 4B, where each shallow-drawn metallic housing 112a, 112b utilizes a separate closure member 118, the implementation in FIG. 4C replaces the closure member 118 with a flange 146. The flange 146 is an integral, outwardly extending rim, or lip, formed around the open face of each shallow-drawn metallic housing 112a and 112b. The flange 146 may be created during the shallow-drawing process of each of the shallow-drawn metallic housings 112a and 112b. More specifically, the flange 146 is a flat, projecting rim that extends perpendicularly from the sidewalls of each shallow-drawn metallic housing 112a, 112b at the open top. The flanges 146 of the shallow-drawn metallic housings may be joined together by heat sealing. Because the inner surface 114 of each shallow-drawn metallic housing 112a, 112b is coated with the first PP layer 116, heat sealing the flanges 146 results in a strong bond, and eliminates the need for a separate closure member 118.

Moreover, the outer enclosure 126 includes the first opening 142 that is located at the bottom side of the inner enclosure 110 and the second opening 144 that is located at the top side of the inner enclosure 110 opposite the bottom side. The first opening 142 may provide a vent with the thermal interface material. The at least one lead tab 122 from each of the two inner enclosures 110 passes through and extends from the second opening 144. The lead tabs 122 may be connected in series or parallel, depending on the desired voltage and current characteristics of the battery pack 18. For a series connection, the positive lead tab 122 of one battery cell 100 is connected to the negative lead tab 122 of the adjacent battery cell 100. For a parallel connection, positive lead tabs 122 are connected together, and negative lead tabs 122 are connected together. The combined lead tabs 122 then exit the outer enclosure 126 through the second opening 144, providing the external electrical connection points for the two-cell module.

With reference to FIG. 5A-5C, various configurations of the outer enclosure 126 are shown. At the top and bottom sides of the outer enclosure 126, the coating layer 128 includes a ceramic coating of alumina, ATH, or a blend thereof. The ceramic coating provides electrical insulation and high-temperature resistance. As shown in FIG. 5B, the coating layer 128 may surround a first inner layer 130 of mild carbon steel. Alternatively, as shown in FIG. 5C, the coating layer 128 may surround a second inner layer 132 of aluminum. Notably, the top and bottom sides of the outer enclosure 126 do not directly interface with other battery cells 100 within the battery pack 18. The second region 140 of the outer enclosure 126 interfaces directly with at least one other battery cell 100. As such, the second region 140 of the outer enclosure 126 includes the coating layer 128 that surrounds the second inner layer 132 and includes an outer sub-layer 134 as shown in FIG. 5D. The outer sub-layer 134 includes a blend of glass bubbles 136 and ATH. As previously described, the combination of ATH and glass bubbles 136 in the outer sub-layer 134 provides a synergistic effect. The ATH contributes to fire retardancy and active cooling through its endothermic decomposition, while the glass bubbles 136 enhance thermal insulation, reducing heat transfer between adjacent cells.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A battery cell comprising:
an electrode assembly including a cathode, an anode, and a separator;
an inner enclosure at least partially surrounding the electrode assembly, the inner enclosure comprising:
a shallow-drawn metallic housing having an inner surface, the inner surface at least partially coated with a first polypropylene (PP) layer;
a closure member comprising a second PP layer, the second PP layer of the closure member sealed to the first PP layer of the shallow-drawn metallic housing; and
at least one lead tab electrically connected to the electrode assembly and extending outwardly from the inner enclosure; and
an outer enclosure surrounding at least a portion of the inner enclosure, the outer enclosure has a coating layer comprising aluminum tri-hydrate (ATH), wherein the outer enclosure has a first region with a first thickness and a second region with a second thickness greater than the first thickness.

2. The battery cell of claim 1, wherein a portion of the coating layer comprises an outer sub-layer, and wherein the outer sub-layer comprises a blend of ATH powder and glass bubbles.

3. The battery cell of claim 2, wherein the portion of the coating layer interfaces with another battery cell.

4. The battery cell of claim 2, wherein the glass bubbles comprise soda-lime borosilicate glass.

5. The battery cell of claim 4, wherein the glass bubbles have a diameter between 15 μm and 70 μm.

6. The battery cell of claim 4, wherein the glass bubbles have a density between 0.1 g/cc and 0.5 g/cc.

7. The battery cell of claim 1, wherein the first region interfaces a thermal interface material.

8. The battery cell of claim 1, wherein the second region interfaces another battery cell.

9. The battery cell of claim 1, wherein the closure member comprises a multi-layer laminated aluminum pouch.

10. A battery pack comprising:
a first battery cell and a second battery cell, each respective battery cell comprising:
an electrode assembly comprising a cathode, an anode, and a separator; and
an inner enclosure at least partially surrounding the electrode assembly, the inner enclosure comprising:
a shallow-drawn metallic housing having an inner surface, the inner surface at least partially coated with a first polypropylene (PP) layer;
a closure member comprising a second PP layer, the second PP layer of the closure member sealed to the first PP layer of the shallow-drawn metallic housing; and
at least one lead tab electrically connected to the electrode assembly and extending outwardly from the inner enclosure; and
an outer enclosure surrounding at least a portion of the inner enclosure of the first battery cell and the second battery cell, the outer enclosure has a coating layer comprising aluminum tri-hydrate (ATH), wherein the outer enclosure has a first region with a first thickness and a second region with a second thickness greater than the first thickness.

11. The battery pack of claim 10, wherein the closure member of the first battery cell interfaces with the closure member of the second battery cell.

12. The battery pack of claim 10, wherein a portion of the coating layer comprises an outer sub-layer, and wherein the outer sub-layer comprises a blend of ATH powder and glass bubbles.

13. The battery pack of claim 12, wherein the portion of the coating layer interfaces with another battery cell.

14. The battery pack of claim 12, wherein the glass bubbles comprise soda-lime borosilicate glass.

15. The battery pack of claim 10, wherein the first region interfaces with a thermal interface material.

16. The battery pack of claim 10, wherein the second region of the first battery cell interfaces the second region of the second battery cell.

17. A battery pack comprising:
a first battery cell and a second battery cell, each respective battery cell comprising:
an electrode assembly comprising a cathode, an anode, and a separator;
an inner enclosure at least partially surrounding the electrode assembly, the inner enclosure comprising:
a shallow-drawn metallic housing;
a flange attached to the shallow-drawn metallic housing;
at least one lead tab electrically connected to the electrode assembly and extending outwardly from the inner enclosure; and
an outer enclosure surrounding at least a portion of the inner enclosure of the first battery cell and the second battery cell, the outer enclosure has a coating layer comprising aluminum tri-hydrate (ATH), wherein the outer enclosure has a first region with a first thickness and a second region with a second thickness greater than the first thickness.

18. The battery pack of claim 17, wherein the flange of the first battery cell interfaces with the flange of the second battery cell.

19. The battery pack of claim 17, wherein a portion of the coating layer comprises an outer sub-layer, and wherein the outer sub-layer comprises a blend of ATH powder and glass bubbles.

20. The battery pack of claim 19, wherein the glass bubbles comprise soda-lime borosilicate glass.
